(19) United States
(12) Patent Application Publication
(10) Pub. No.: US 2008/0235282 A1
(43) Pub. Date: Sep. 25, 2008

(54) Personal Computing Apparatus and a Method Therein

(76) Inventors: Petter Ericson, Malmo (SE); Mattias Bryborn, Lund (SE)

Correspondence Address: BIRCH STEWART KOLASCH & BIRCH, PO BOX 747, FALLS CHURCH, VA, 22040-0747, US

(21) Appl. No.: 11/922,691

(22) PCT Filed: Jun. 16, 2006
(86) PCT No.: PCT/SE2006/000735

§ 371 Date: Dec. 21, 2007

Related U.S. Application Data
(60) Provisional application No. 60/691,234, filed on Jun. 17, 2005.

(30) Foreign Application Priority Data
Jun. 17, 2005 (SE) 0501395-8

(51) Int. Cl. G06F 17/00

(52) U.S. Cl. 707/104.1

(57) ABSTRACT

A personal computing apparatus has a position code repository, which stores a representation of a plurality of subsets of a position code, and a code assigner, which on request assigns at least one of said subsets to a document stored in the personal computing apparatus. In this way local on-demand printing of position-coded base can be performed. The subsets of the position code represented in different personal computing apparatuses may be the same.

### CROSS-REFERENCE TO RELATED APPLICATIONS

The present application claims the benefit of Swedish patent application no. 0501395-8, filed on Jun. 17, 2005 and U.S. provisional patent application No. 60/691,234, filed on Jun. 17, 2005, both of which are hereby incorporated by reference.

### FIELD OF THE INVENTION

The present invention generally relates to information management, and more specifically to on-demand generation of position-coded bases and processing of information recorded from such bases.

### BACKGROUND ART

Information management systems for managing handwritten information are known; see e.g. US 2003/0061188, US 2003/046256 and US 2002/0091711. In these systems an electronic pen records pen strokes made on a base provided with a position code which codes a plurality of absolute positions on the base. The pen records the pen strokes by imaging the position code at the tip of the pen and decoding the coded positions so that a sequence of positions reflecting the pen movement is obtained.

The position code on each base is only a small part of a much larger abstract position code. This overall position code may be divided into different segments, which are associated with different processing rules. Thus, bases may be provided with position code from different segments of the overall position code in order to enable differentiated processing of pen strokes. The segments may be further divided into subsets, each of which may e.g. substantially correspond to a document page. In this way different bases intended for the same pen stroke processing may be provided with different subsets of the position code, enabling the information management system to distinguish pen strokes from different bases using only the positions by which the pen strokes are represented.

Besides being provided with the position code, the bases may also be provided with a graphical layer, comprising text, images, symbols, boxes, frames or any other human-understandable indications that are usually found on a document or any other information product.

Bases with both a graphical layer and a position code may be distributed to users as ready-to-use products. Alternatively users may obtain bases with a preprinted position code so that they may print the graphical layer themselves using local printers. Yet another alternative is to enable on-demand generation of bases. The present invention concerns the third alternative and more specifically the problem of how to make possible on-demand generation in a convenient manner while ensuring that e.g. the digital pens and/or computers in the information management system can separate pen strokes made on different bases.

WO 2004/038651, which is hereby incorporated by reference, relates to an information processing system having an arrangement for enabling on-demand printing of position-coded bases. When the user, via a browser program on his computer, has chosen a graphics file to be printed from a network-based graphics repository, the browser program requests position data from a network-based position assigner, which has access to a database with at least part of the overall position code. The position assigner returns position data and the browser program then puts together a coding layer and a graphics layer in a printout file which is sent to a printer to be printed on a suitable substrate.

A potential drawback is that the on-demand printing of position-coded bases according to this solution requires the availability of network resources.

### SUMMARY OF THE INVENTION

An object of the present invention is to provide an alternative solution for on-demand generation of position-coded bases.

This object is at least partly achieved by a personal computing apparatus according to claim 1 and a method in a personal computing apparatus according to claim 13.

According to a first aspect of the invention, a personal computing apparatus comprises a position code repository, which stores a representation of a plurality of subsets of a position code, and a code assigner, which on request assigns at least one of said subsets to a document stored in the personal computing apparatus.

According to this method the position code assignment is carried out locally in the user's computing apparatus, for instance in his personal computer, without having to use network resources.

The subsets stored in the position code repository need not be unique and thus no centralized administration of the position code is required. At least a plurality of the subsets represented in the position code repository may also be represented in another position code repository of another personal computer apparatus in the same information system. The subsets of the position code represented in all position code repositories may even be exactly the same in all personal computer apparatuses in the system. In this way standardized position code repositories may be distributed to the users in the information management system.

The code assigner may select a subset from the representation of the plurality of subsets in the position code repository by using e.g. a randomized algorithm. In this way the risk that different user simultaneously generate bases with the same position code is reduced.

If the number of subsets represented in the repositories are moreover chosen to be large in relation to the expected number of print-outs of documents the risk that one or more users within a short period generates two bases with the same position code is reduced.

Furthermore, the code assigner may assign an information code, which codes non-positional information, to the document. The non-positional information may help to make bases unique within an information management system and to separate pen strokes made on different bases. More specifically the information item may be a parameter used in the processing or routing of the pen stroke information, e.g. an address to which information recorded from the base is to be sent or an encryption key or a unique identifier. The information code may be overlaid on the position code and the information item may be repeatedly coded in the information code so that a digital pen used to electronically record pen strokes from the base may record the information item independently of where on the base the pen stroke is made. The information code may be used on any document independently of where and how the assignment of position data is carried out.

The personal computing apparatus can be any computing apparatus which is intended to be used by one user at the time. It could for instance be a PC, a PDA (Personal Digital Assistant), or a mobile phone.

The code assigner may be implemented as a set of software instructions which are executed by a processor in the personal computing apparatus. It could also be implemented in specifically adapted hardware.

The software instructions that implement the code assigner may be stored, possibly together with the position code repository, on a computer-readable storage medium, and distributed to the users. The computer-readable storage medium may e.g. be an electronic memory; an optical disk; a magnetic disk or tape; or some other commercially available storage medium. The storage medium can also be a propagating signal.

The position code repository may be stored in a persistent memory of the personal computer.

According to another aspect of the invention, a method in a personal computing apparatus comprises providing a document, and assigning at least one subset from a representation of a plurality of subsets of a position code stored in the apparatus to the document.

### BRIEF DESCRIPTION OF THE DRAWINGS

The invention will now be described more in detail by way of examples, reference being had to the accompanying schematic drawings.

FIG. 1 is a schematic overview of a system in which the present invention may be used.

FIG. 2 is a schematic illustration of an embodiment of an information code.

FIG. 3 shows four different locations of a coding symbol in an embodiment of a position code.

FIG. 4 is a schematic illustration of an embodiment of a part of a position code.

FIG. 5 schematically shows the different displacements of the coding symbols in an embodiment of a combined code.

FIG. 6 schematically illustrates an example of a cell of a combined code.

FIG. 7 schematically shows how elements of information items may be permuted in one embodiment of a combined code.

FIG. 8 schematically shows an embodiment of a digital pen which can be used for recording and decoding a combined code.

FIG. 9 schematically shows an installation in a personal computing apparatus which makes possible the local on-demand generation of position-coded bases.

FIG. 10 schematically shows how pen strokes may be incorporated in a document which has been printed as a position-coded base.

### DETAILED DESCRIPTION OF EMBODIMENTS OF THE INVENTION

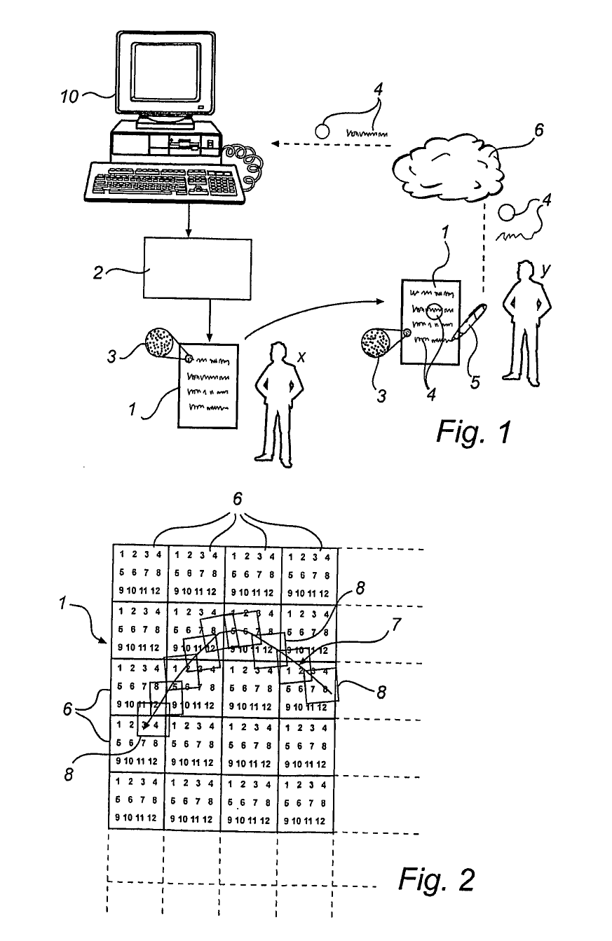

FIG. 1 shows an example of an information management system in which local generation of position-coded bases can be used.

Assume that a person X has created a document, which is stored in a memory of his computer 10. X wants a person Y to review the content of the document. X prints the document 1 on a base using a printer 2. The base could be made of any material which makes the base suitable for being printed on. A position code 3, a part of which is schematically shown in enlarged format in the figure, is also printed on the base. The position code will enable Y to electronically record annotations 4 made by him using a digital pen 5, which records the position code.

It would furthermore be beneficial if the annotations recorded by Y's pen 5 could be transmitted back to X's computer 10 and incorporated in the original document for X's review. To achieve this, Y's pen 5 or another unit to which Y's pen transfers the electronically recorded annotations 4, needs to know the address to which the annotations are to be sent.

In order to enable local assignment of position code to document 1, X's personal computer 10 is provided with a code assigner and a position code repository. The position code repository contains a representation of a large number of subsets of the complete position code. The subsets may correspond to the whole position code or one or more parts thereof. The number of subsets is made statistically large in relation to the number of users, the number of print-outs, the expected manner of using the documents, etc. A person skilled in the art is capable of designing the size of the position code repository.

X's personal computer may be part of an information management system, which may comprise a plurality of other personal computers each of which is provided with a position code repository and a position assigner, so that position-coded bases may be generated locally on-demand. X's personal computer and other personal computers in the system may or may not have network connections. They may or may not be able to receive pen strokes from bases generated by themselves or any other computer in the information management system. The information management system may furthermore comprise one or more printers and/or one or more digital pens and/or one or more routing units, such as a mobile phone, a PDA or a computer, which route pen strokes from a digital pen to a receiving unit, such as a mobile phone, a PDA or a computer.

The subsets of the position code represented in the position code repository may be the same in all computers in an information management system.

The subsets represented in the position code repository may be divided into chunks of related subsets. The subsets within a chunk need not necessarily be adjacent each other in the overall position code. It suffices that it exists a way of determining that two subsets belong to the same chunk, e.g. by means of a predetermined algorithm. Information about the division into chunks of the subsets in the repository may be stored in or input to the digital pens or other units which decode the code on the bases.

The position assigner may use a randomized algorithm or sequence to select a subset from the representation of subsets in the repository. It could be truly random or pseudo-random. The algorithm or sequence may be so arranged that all the subsets are stepped through before a specific subset is selected by the position assigner for the next time. The subsets may also be selected in an ordered way, e.g. sequentially. Depending on the size of the repository, the number of print-outs, and the frequency of usage of the printed-out bases, there may be no need to keep track in the repository of which subsets have already been assigned, because it takes such a long time before the same subset is assigned the next time that the base provided with that subset is most probably no longer used in the system and no conflict will arise if a new document is provided with the subset.

One way to solve the above-mentioned problem with how to send back Y's annotations 4 to X's computer, may include the use of a look-up server, which stores an association between the positions coded by the position code 3 on X's document and the network address of X's computer. This solution requires, however, that the intermediary server is available and has been informed about what subset of the position code has been printed on X's document and the address where to send the annotations.

Another way would be to provide an information code, which would code the required address information on X's document. The information code may be printed in a separate field on the document to be separately recorded by Y's digital pen 5. Alternatively the information code may be overlaid on the position code and may repeatedly code the address indication. Y's pen 5 may then capture the address information while recording the annotations 4 and use it to send the annotations directly to X's computer 10, for instance via a network 6, such as the Internet or a public telecommunication system, using preexisting general messaging concepts, like e-mail, SMS, fax, HTTP, or FTP.

It should be emphasized that coding an address indication in the information code is but an example of the use of an information code. The information code may be used to code any non-positional information item. This information item may be a parameter which is used in the processing or routing of pen strokes. The parameter may also be used to uniquely identify the base provided with the information code.

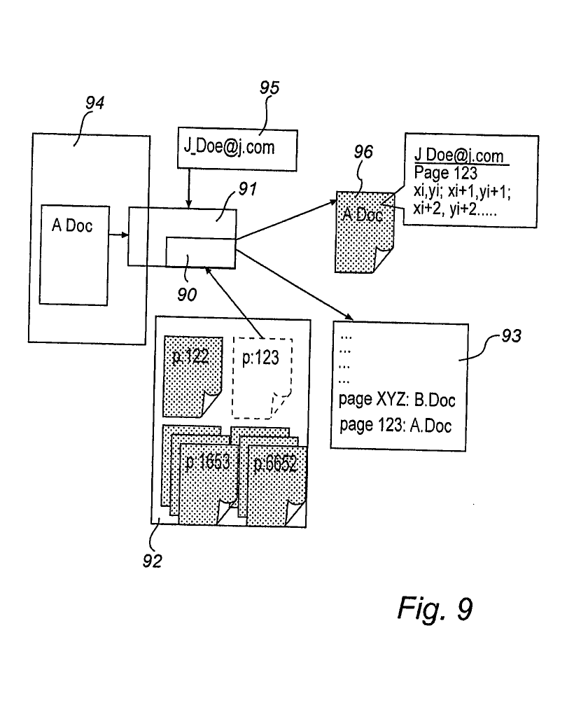

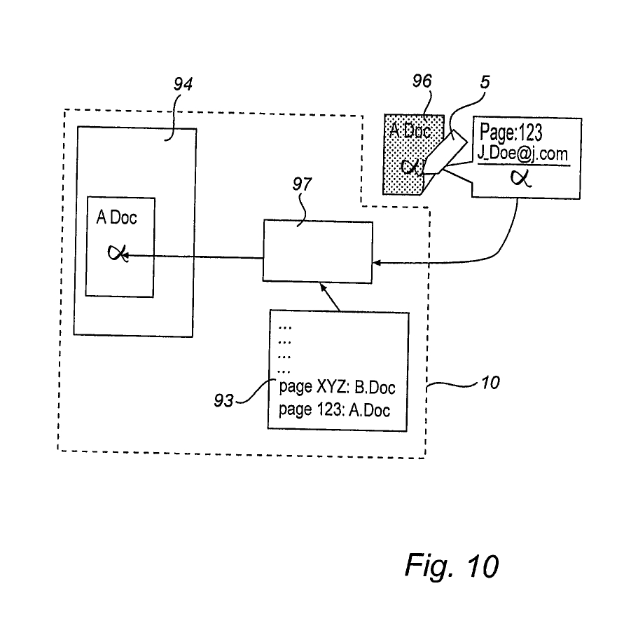

In the following an example of an information code, a position code and a digital pen will first be described more in detail with reference to FIGS. 2-8. Then the installation in the user's personal computing apparatus will be described with reference to FIGS. 9-10.

FIG. 2 illustrates some basic principles of an exemplary information code which can be overlaid on or integrated with or embedded in a position code on a base, such as position code 3 on X's document 1, to create a combined code. The information code may consist of a number of cells 6 which tile the surface of a base 1. The cells may have fixed positions in relation to the position code (not shown in FIG. 2) and thus cell coordinates of a current cell seen by a digital pen moving over the combined code can be determined from the position code, provided that the size of the cells are known. Each cell may code the same piece of information by means of a plurality of coding symbols in each cell. Each cell may thus code one instance of the information item. The information item may consist of a plurality of information item elements. In the example shown in FIG. 2, the information item consists of twelve elements numbered 1-12 in the cells 6. Each element may be coded by one or more coding symbols or marks. The information item may e.g. consist of binary data, each bit of which is coded by one coding symbol in the information code. Each information item element may thus represent one or more data bits.

The cells of an information code may include a larger number, a lesser number or the same number of coding marks as is required for determining a position by means of the position code.

As soon as a current position of the pen has been determined by means of the position code, the current cell seen by the pen can be determined using the cell size. Also, the number of each information item coding symbol seen by the pen and the corresponding information item element number can be determined using the position code, the cell size and information about how the information item is coded by the coding symbols.

A user may make one or more pen strokes 7 on the document 1. A pen stroke may be recorded as a sequence of spatially and temporally related positions. The pen may for instance be provided with a contact detector which detects when the pen is put down on the base and subsequently lifted from the base. The positions recorded between a “pen-down” and the next “pen-up” may be defined as a pen stroke.

While a pen stroke 7 is made, the digital pen typically moves across a number of cells 6. The field of view of the pen may or may not be sufficiently large for the pen to record one complete information code cell in a single image. In the example of FIG. 2, each image 8 captured by the pen during a pen stroke 7 will include only a couple of information elements. But as the pen moves, further images 8 including different information elements in different cells will be captured and eventually all the elements 1-12 of the information item will be recorded. The pen may then use the information about the elements gathered from different cells to decode the information item that is repeatedly coded in the cells of the information code.

The information item coded in the cells of the information code can be any information that can be coded by the available information space in a cell. It may be non-positional data. It can for instance be an address indication, e.g. an e-mail address of an originator of a document or a URL to which a document is to be sent, or information about the layout of the base which helps an application which receives information from the base to correctly process the information, or encryption information, e.g. an encryption key, which may be used to encrypt pen strokes recorded from the base, or an access information item, which may be used to restrict usage of the base to certain pens.

The position code on which the information code is overlaid can be any kind of position code that codes absolute positions on a surface. Each position can be coded by a single symbol, which, depending on the number of positions coded by the position code, may be rather complex. Alternatively, each position may be coded by two or more less complex symbols. The simplest symbols can be used in position codes where each symbol only codes one of two possible values. In this case the symbol only has to have two discernible states.

Also, the position code may tile the base, such that each position is coded by means of one or more symbols that are used exclusively for coding that position. Alternatively the position code may be “floating” such that any part area of a predetermined size of the position code defines a position. In this case at least some of the symbols that are used for coding a position also contribute to the coding of another position.

Below follows an exemplifying description of a specific position code that can be used in a combined code, which codes both position indications and one or more recurrent pieces of information. The position code is of the kind described in U.S. Pat. No. 6,667,695, which is hereby incorporated by reference and to which reference can be made for further details.

The position code is based on a number sequence which below is referred to as a difference number sequence. This difference number sequence has the property that if one takes an arbitrary partial sequence of a predetermined length, for instance a partial sequence with five difference numbers, this partial sequence always has an unambiguously determined location in the difference number sequence. In other words, it appears only once in the difference number sequence and can thus be used for position determination. A sequence having this property is sometimes called a DeBruijn sequence. More specifically, the difference number sequence “runs” along the x axis as well as along the y axis of the position code.

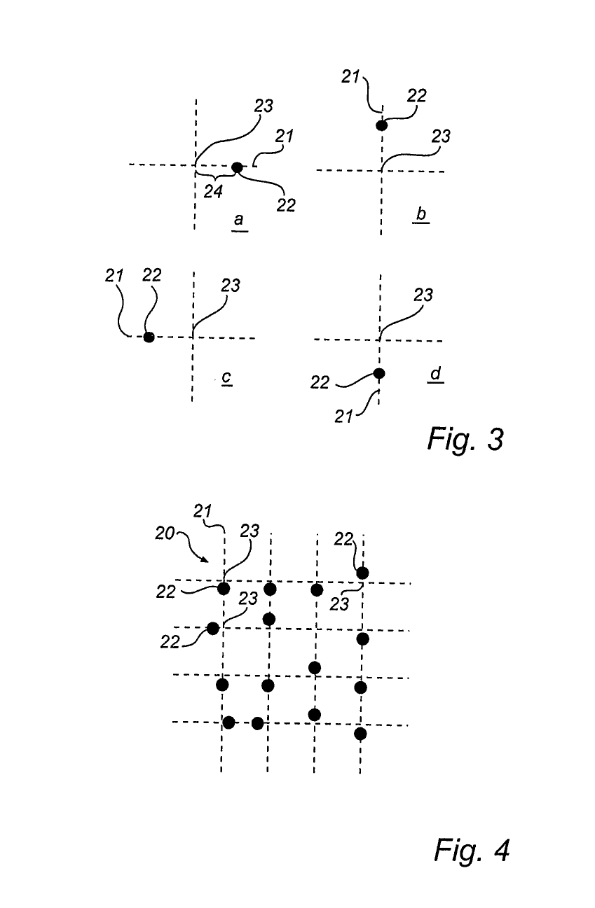

The actual position code as applied on a base is made up of simple graphical symbols or marks 22 which can assume four different values, 0-3, depending on their respective position in relation to a nominal position 23 or raster point. As seen in FIG. 3, each symbol 22 has the shape of a dot and is displaced a distance 24 in one of four different directions relative to the nominal position 23. The nominal position 23 is at an intersection between raster lines 21 in a visible or invisible or virtual raster or grid. The value coded by the symbol is determined by the direction of the displacement. Each symbol value 0-3 can be converted into one bit which is used for coding an x coordinate and one bit which is used for coding a y coordinate, i.e. into the pairs of bits (0,0), (0,1), (1,0), and (1,1). Thus, the coding is made separately in the x direction and the y direction, but the graphical coding is made with a symbol which is common to the x and y bits.

It should be mentioned that the coding may for instance be as follow:

| Displacement | Bit pair (x, y) |
|---|---|
| Right | 0, 1 |
| Up | 0, 0 |
| Left | 1, 0 |
| Down | 1, 1 |

The distance 24 is suitably not less than about ⅛ and not more than about ¼, preferably about ⅙, of the distance between two adjacent raster lines 21.

Each position is coded by 6*6 symbols which can thus be converted into a 6*6 bit matrix for an x coordinate and a 6*6 bit matrix for a y coordinate for the position. If the x bit matrix is considered, this can be divided into six columns of six bits each. Each sequence of bits in a column constitutes a partial sequence in a 63-bit-long cyclic main number sequence which has the property that if a partial sequence having a length of six bits is selected, this has an unambiguously determined place in the main number sequence. The six columns can thus be converted into six position numbers or sequence values which correspond to six places in the main number sequence. Between these six position numbers, five difference numbers can be formed in neighboring pairs, which constitute a partial sequence of the difference number sequence and which thus have an unambiguously determined place in the same and, consequently, an unambiguously determined place along the x axis. For a certain x coordinate, the position numbers will vary depending on the y coordinate. On the other hand, the difference numbers will be the same independently of the y coordinate, since the position numbers always vary according to the main number sequence, which is repeated cyclically in the columns in the entire position-coding pattern.

Correspondingly, six rows in the y bit matrix define six position numbers in the main number sequence. These six position numbers define five difference numbers, which constitute a partial sequence of the difference number sequence and which thus have an unambiguously determined place along the y axis.

FIG. 4 shows a very small part of the above-described specific position code with 4*4 symbols. The raster lines 21 are shown in the figure for illustration purposes only. In general, the raster is virtual.

When a digital pen is used on the position code, it may capture images of different parts of the position code. The images may contain considerably more than 6*6 symbols. Thus the position code may be decoded based on different sets of 6*6 symbols if a larger number of symbols are visible in the image. Surrounding symbols may also be used in the decoding, inter alia, for error detection and/or correction. It should however be noted that even if the field of view of the digital pen comprises a larger number of symbols than is strictly required for the decoding of a position, the numbers of useful symbols in the recorded image may be considerably smaller due to e.g. image distortion.

The above-described exemplary position code is of a so called “floating type”. It means that any arbitrary partial area comprising a predetermined number of symbols, here 6*6 symbols, will define a position and that at least some of the symbols in the arbitrary partial area contribute to the coding of more than one position. Otherwise stated, if the arbitrary partial area is moved a symbol distance up, down, to the left or to the right, a new position will be defined by the symbols in the arbitrary partial area thus moved. Thus, a unique x,y coordinate can be determined for each coding symbol in the position-coding pattern

The above-described exemplary position code is capable of coding a very large number of unique absolute positions. The positions can be considered as jointly defining a huge imaginary surface. The positions coded on a base are positions on this imaginary surface and the origin of the position coordinates is the origin of the imaginary surface.

The imaginary surface or the overall position code can be logically subdivided into pages of different sizes. Any unit, e.g. a digital pen or a computer, having knowledge about the subdivision of the imaginary surface may thus convert a position on the imaginary surface recorded from a base to an indication of the corresponding page and a local position on that page.

Also, different bases may be provided with different subsets of the overall position code.

It should be emphasized that the position code described above is just an example. Other kinds of position codes, e.g. position codes coding fewer positions and having the origin on the base could also be used.

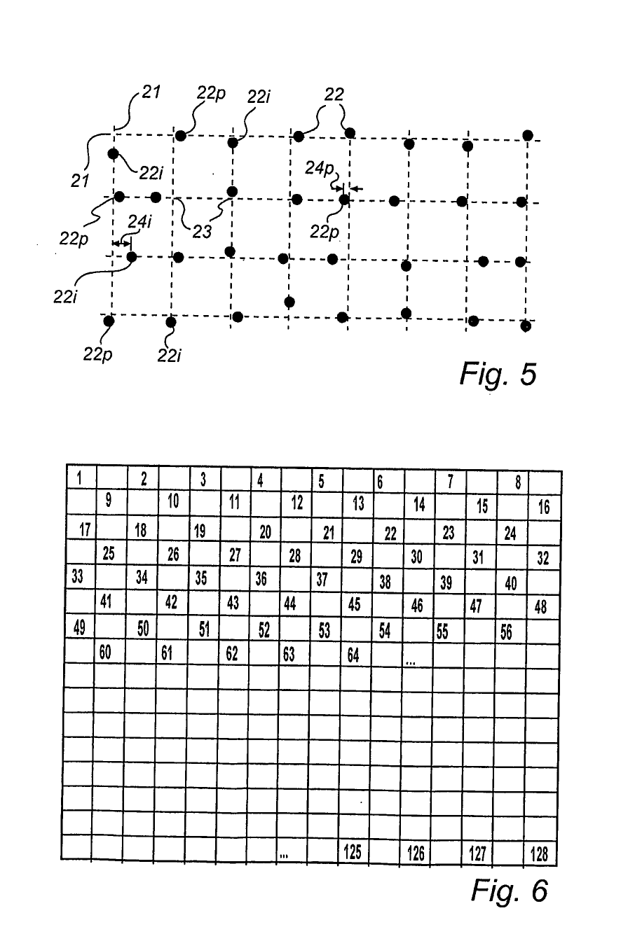

Next an embodiment of an information code will be described more in detail with reference to FIGS. 5-7.

Generally, an information code can be overlaid on the position code either by being superimposed on the position code, in which case the piece of information is coded by symbols which are also used in the position code for coding positions, or by being interleaved with the position code, in which case the position code and the information code use separate symbols for the coding of positions and information, respectively. A combination of interleaving and superimposition is also conceivable. In that case some of the symbols in the combined code are used for position coding as well as information coding, some for position coding only and some for information coding only.

An information code may be overlaid on the position code on either the whole extent of the position code on the base or only part(s) thereof.

An information code and a position code can be graphically differently or identically coded on a base. If separate symbols are used for the position code and the information code, such as when the codes are interleaved, the graphical representation of the information code symbols and the position code symbols, respectively, may be made independently of each other. Both codes may use the same graphical parameter, e.g. dots of different sizes to code different values of the symbols. Or the codes may use different parameters. The information code may e.g. use slashes that are differently rotated to code different values, whereas the position code may use dots of different shapes to code different values.

If the information code and the position code share some symbols, one and the same parameter of the symbols may be used for coding the information code value and the position code value. Alternatively different parameters may be used. In the first case, the different combinations of a position code value and an information code value may e.g. be coded in different sizes of the symbols or in the displacements in different directions of the symbols. In the second case, the position code value may e.g. be coded in the direction of displacement of a dot and the information code value may be coded by different colors or color intensities of the dot.

The symbols of a combined position and information code may be divided into groups according to predetermined rules. Each group may comprise a predetermined number of symbols belonging to the position code and a predetermined number of symbols belonging to the information code. The groups can be formed in any conceivable way provided that there is an algorithmic way of correlating symbol location, i.e. position on a base as determined by the position code, with a specific coding symbol of the information code. The symbols may for instance be divided into cells which tile the combined code, like in FIG. 2. A cell could be defined as a coherent area in the combined code, within which all the information coding symbols code one and the same instance of the information item. The size and the shape of the cells may vary between different bases and depending on the piece of information to be coded in the information code. The groups may e.g. include 32, 64, 128, 256 or 1024 symbols belonging to the information code.

As an alternative to the algorithmic way of correlating symbol location with a specific coding symbol of the information code, the cells may be marked graphically on the base, e.g. by additional marks on the base or by a specific feature of marks belonging to the position code and/or the information code, so that the boundaries of the cells can be optically detected.

As indicated above, each group of symbols may include a larger number of symbols than can be seen by the pen within its field of view. This may permit the coding a larger amount of data in the information item.

All groups may code the same piece of information or possibly a small number of different pieces of information. In the latter case, a decoding device needs to be able to distinguish which groups code a first piece of information, which groups code a second piece of information and so on.

Below an example of a specific implementation of a combined code which is applied on a base, e.g. a paper, is described with reference to FIG. 5, which schematically shows a small part of a combined code. All symbols 22 in FIG. 5 are used for the position coding and thus belong to the position code. They are furthermore all offset in either of four directions from a respective nominal position 23, which is defined by an intersection of the raster lines or grid lines 21.

The information code is superimposed on the position code, such that the information code makes use of symbols which are also used for coding positions. In this example every other symbol in the position code (e.g. where (x+y≡0 modulo 2)) starting from the upper left corner is used for the information code. In FIG. 5 dots 22i belong both to the information code and the position code, whereas dots 22p belong only to the position code. The positions are coded by a variation in the direction of displacement of the coding symbols belonging to the position code. The size of the displacement 24p is the same for all four directions. The information item is coded by a variation in the extent of the displacement of the coding symbols belonging to the information code. In this example, each information coding symbol is either offset the ordinary distance 24p from the nominal position to code a “0” or twice the ordinary distance 24i from the nominal position to code a “1”.

FIG. 6 schematically shows an example of a cell of a combined code. The cell of FIG. 6 comprises 16*16 coding symbols of the position code. Every other symbol is used to code information, like in the example of FIG. 5. Every square in FIG. 6 corresponds to a coding symbol of the position code. The numbered squares correspond to the coding symbols that also belong to the information code. In this case, the information item may consist of 128 bits of data at a maximum and each bit is coded by one information coding symbol. More generally, an information item may consist of a plurality of information item elements, each of which may be coded by one or more coding symbols.

Some of the symbols may be used for error correction, using e.g. an industry standard binary BCH code, such as BCH(127,99,9), which means that 127 bits are used for information coding, of which 99 bits are used for data and 28 bits for error correction, making it possible to correct for four bit errors or eight missing bits. One bit is left unused. Other error correcting schemes are of course conceivable.

The sequence of information bits may be identical in all cells of an information code. However, the sequence may also be permuted between cells in order to increase the probability of catching all the information item elements during the recording of the pen strokes on the base e.g. if the pen cannot image a complete information item at one time. A permutation function for the information bits 1 . . . 128 of FIG. 6 may have the following form:

P(xi,yi,bit_number)=permuted_bit_number

Where xi and yi are integers representing the cell coordinates and bit-number is an integer between 1-128 indicating the sequential number of the bit in the cell. xi can be calculated as the integer part of x/xsize, where xsize is the cell size in the x-direction expressed as number of symbols and x is the x-coordinate of the current coding symbol in the overall position code. yi can be calculated in the corresponding way as the integer part of y/ysize, where ysize is the cell size in the y-direction expressed as number of symbols and y is y-coordinate of the current coding symbol in the overall position code. Bit_number may be calculated as Bit_number=x mod xsize+C*y mod ysize, where C is a constant equal to the number of information code elements in the x-direction, which is 8 in this example. Permuted_bit_number will also be a number between 1 and 128 representing the number of the information item element. Thus, in this example the function P is a one-to-one mapping of 1 . . . 128 onto 1 . . . 128.

The skilled person can conceive different functions P that result in more or less complicated permutations of the information bit sequence.

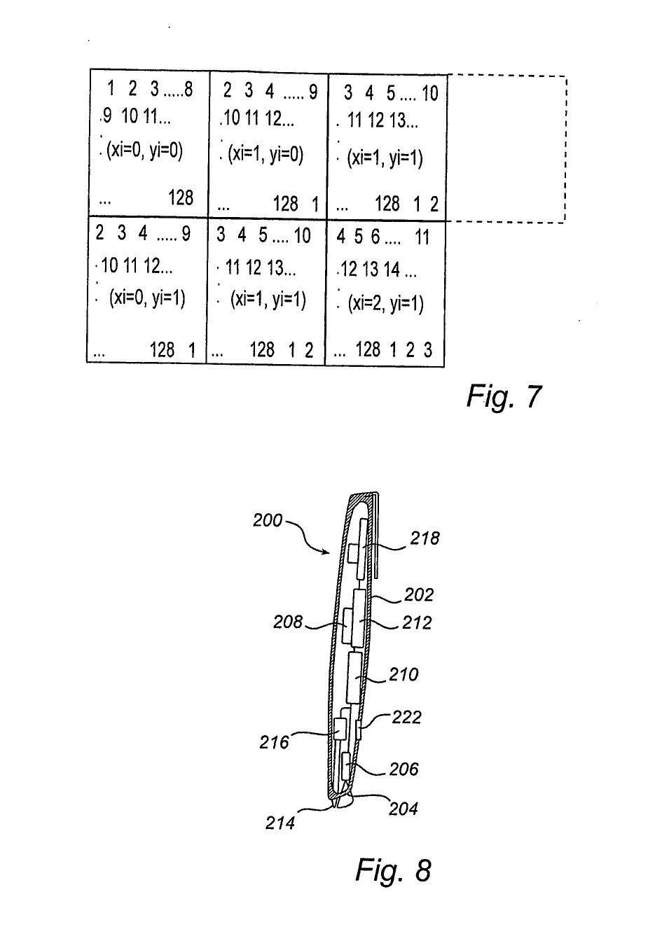

FIG. 7 schematically illustrates the permutation resulting from the following permutation function:

P(xi,yi,bit number)=(bit_number+xi+yi) mod 128+1

FIG. 7 shows six exemplary information code cells. The cell coordinates of each cell are indicated inside each cell. As is evident from FIG. 7, the permutation function shifts the information bit sequence one step forward when moving one cell to the right or one cell downwards.

In the above-described example, 128 binary bits can be coded into the information code cell. Thus, any kind of information that can be represented by 128 bits, including any error correction, may be coded into the exemplary information code cell of FIG. 6. By using a larger part of the coding symbols in the information code cell, e.g. every coding symbol instead of every other coding symbol, the information coding density may be increased without increasing the cell size. Alternatively or as a supplement, the cell size may be increased. This may however result in that more pen strokes need to be made on the base before the information item is captured.

The above-described permutation is just an example of how the coding of the information item may be varied between the cells in order to increase the likelihood that all elements of the information item are seen during different kinds of pen strokes. Another kind of variation is obtained by not coding the complete information item in every cell, but to leave out one or more information item elements and/or to code one or more elements more than once in one or more cells. It is realized that these different methods of varying the coding of an information item may also be used in combined codes where the cell comprises the same number of coding symbols as is required for the coding of a position or less.

Next will be described an example of how the combined code could be generated. In this example, it is assumed that the information item consists of 128 bits without any error correction and that the permutation function P is the one indicated above.

A combined code may be generated in a coding module of an apparatus, which may comprise a processor of some suitable type, different kinds of memory and other units typically used for data processing. The apparatus may be a general computer, a printer, another standard device or special-purpose device. It may be an apparatus which is local or remote in relation to the user.

In a first step of the code generation, the coding process of the coding module generates the position code to be provided on the base. To this end, the coding module may receive as an input signal an indication of the size of the position code to be generated, e.g. the number of columns and rows to be included in the position code, and the coordinate area to be used, e.g. starting from a specific x,y coordinate pair. The input signal may originate from e.g. a user or the system. It may for instance come from a code assigner in the system.

Based on the input signal, the coding process may create a matrix or another data structure representing all the coding symbols of the position code. Next it may step through all the elements in the matrix associating, with each element, a value which indicates which graphical state the corresponding coding symbol shall have when applied on the base in order to code the relevant position. In this example the value indicates the direction in which a symbol is to be displaced.

A more detailed example of how the displacement values of coding symbols coding a specific position may be calculated could be found in U.S. Pat. No. 6,667,695.

The output of the position code generation step may be the matrix with the graphical state values, which is one example of an electronic representation of the position code. The position code data may be organized in different data structures, e.g. a list.

In a next step, an information item may be input to the coding module, either by the user or from another part of the system. The information item may e.g. be static and used for all documents, it may vary depending on what subset of the position code is used, or it may vary freely as decided by the user. Conversion of information item data to binary format and calculation of error correction bits may also be performed in this step.

Before coding of the information item starts, the cell size may need to be defined. This can be done e.g. by a user selection or based on the information item to be coded. The cell size may also be predetermined and one and the same for all combined codes created by the relevant coding process.

To overlay the information code on the position code and code the information item into the coding symbols of the position code, all the points in the position code matrix may be looped over by the coding process. More specifically, the coding process may use a predetermined algorithm to determine which symbols in the position code should be used for the information code. In this example, the coding process skips every other symbol in the position code matrix to make the information coding in a chess-board fashion, as has been described above in connection with FIG. 5.

For each information coding symbol, the coordinates of the position code may furthermore be used to calculate xi, yi and bit_number as described above. Then the permutation function P(xi, yi, bit_number) may be used for deciding which information item element is to be encoded by the current information coding symbol. If the binary value of the information item element is 1, the graphical state value of the coding symbol may be modified to indicate that the offset should be twice as big as that used for position coding. If on the other hand the binary value of the information item element is 0, the graphical state value of the coding symbol may be left unmodified to indicate that the normal offset is to be used when printing that coding symbol. This step, thus, means that cells are defined in the position code and that the information item is coded in the cells.

As a final step a print file may be created from the graphical state matrix and the combined code printed on a base. The print file may also include instructions to the printer to print a document, a form, an image or any other kind of information together with the combined code.

The combined code on the one hand and any other information on the other hand may be printed on the base using one and the same ink or separate inks, where the ink used for printing the other information is transparent to the digital pen. When the same ink is used both for the combined code and the other information, the combined code may be partly obscured if the other information is overlaid on the combined code and special account may have to be taken to this fact in the decoding process.

It should be emphasized that the description above of the encoding process is made for illustration purpose only. The skilled person may conceive other and/or more efficient processes for implementing the generation of the combined code.

Also, the example above relates to a case where the information item consists of binary data and each information coding symbol codes one bit of information. The skilled person can easily modify the example above for a case where each information item coding symbol codes more than one bit of data or a case where each information item element is coded by more than one coding symbol.

Also, the example above relates to a case where a combined code is used on a document. In another embodiment only the position code is generated and printed on a base.

Before describing an example of a method for decoding the combined code, an example of a digital pen, which can be used for the recording and/or decoding of a combined code or only a position code, will be described. To this end, FIG. 8 schematically shows an embodiment of a digital pen 200. The pen 200 has a pen-shaped casing or shell 202 that defines a window or opening 204, through which images are recorded. The casing contains a camera system, an electronics system and a power supply.

The camera system 206 comprises at least one illuminating light source, a lens arrangement and an optical image reader (not shown in the Figure). The light source, suitably a light-emitting diode (LED) or laser diode, illuminates a part of the area that can be viewed through the window 204, by means of infrared radiation. An image of the viewed area is projected on the image reader by means of the lens arrangement. The image reader may be a two-dimensional CCD or CMOS detector which is triggered to capture images at a flexible, adaptive or fixed rate, typically of about 70-100 Hz. Alternatively, the sensor may include a magnetic sensor array for detection of a magnetic property of the symbols. Still further, the sensor may be designed to form an image of any chemical, acoustic, capacitive or inductive property of the symbols.

The power supply for the digital pen is a battery 208, which alternatively can be replaced by or supplemented by mains power (not shown).

The electronics system comprises a control unit 210 which is connected to a memory block 212. The control unit 210 is responsible for the different functions in the pen and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 212 comprises preferably different types of memory, such as a working memory (e.g. a RAM) and a program code and persistent storage memory (a non-volatile memory, e.g. flash memory). Associated software is stored in the memory block 212 and is executed by the control unit 210. Software for decoding a combined information and position code or only a position code may thus be stored in memory block 212 and executed by the control unit 210.

The casing 202 also carries a pen point 214 which allows the user to write or draw physically on a surface by an ordinary pigment-based marking ink being deposited thereon. The marking ink in the pen point 214 is suitably transparent to the illuminating radiation in order to avoid interference with the opto-electronic detection in the electronic pen. A contact sensor 216 is operatively connected to the pen point 214 to detect when the pen is applied to (pen down) and/or lifted from (pen up), and optionally to allow for determination of the application force. Based on the output of the contact sensor 216, the camera system 206 is controlled to capture images between a pen down and a pen up.

The electronics system further comprises a communications interface 218 for the communication of data to a nearby or remote apparatus such as a computer, mobile telephone, PDA, network server, etc. The communications interface 218 may thus provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network.

The pen may also include an MMI (Man Machine Interface) which is selectively activated for user feedback. The MMI may include a display, an indicator lamp, a vibrator, a speaker, etc.

Still further, the pen may include one or more buttons 222 by means of which it can be activated and/or controlled.

The above-described embodiment of the pen 200 is but an example. Other digital pens with a subset of the above-mentioned components and/or partly or wholly other components and/or partly or wholly other designs may be used to record a combined code or a position code. A less complex digital pen may for instance only be capable of recording images and transferring them to another apparatus for further processing. In another embodiment, the digital pen may detect features of the code, such as locations of dots and transfer information thereof to another apparatus for further processing.

Below, one exemplary embodiment of a method for decoding a combined code will be described with reference to the above-described digital pen 200 and the above-described exemplary combined code.

When the above-described pen 200 is used on a base with a combined code, the contact sensor 216 detects when the pen point is pressed against the base and triggers the camera system 206 to capture images of the part area of the combined code within its field of view. The camera continues to capture images until the contact sensor 216 detects that the pen is lifted from the base. The series of images captured by the camera system 206 constitutes a series of electronic representations of different part areas of the combined code.

The decoding of combined code in the series of electronic representations may be carried out in a decoding module of the digital pen or in a decoding module of another apparatus to which the electronic representations are transferred from the pen. The electronic representations may be transferred as captured or in a more or less processed form. The decoding may alternatively be divided between the digital pen and another apparatus, so that the digital pen performs a first part of the decoding and the other apparatus performs a second part.

In a first step of the decoding process of the decoding module, a position is determined for an image captured by the pen. Decoding of a position code of the above-exemplified type, may comprise the steps of localizing the coding symbols in the image, fitting a raster to the coding symbols, determining the direction of displacements of the coding symbols from the nominal positions defined by the raster line intersections and calculating the positions based on the displacements of the coding symbol. For a more detailed description of how the different steps of the position decoding can be carried for this kind of position code, it is referred to e.g. U.S. Pat. No. 6,667,695 and US 2002/0044138, which is hereby incorporated by reference.

It should also be mentioned that the positions need not necessarily be determined from the position code by calculation. The position code can also be used to determine a position by matching the coding symbols of a captured image against a representation of the position code within a certain area where the pen is predicted to be or by matching the coding symbols in a received electronic representation against a previously received electronic representation in order to establish a relative position.

When the locations of the coding symbols in an image have been determined and an x-y position referring to a coding symbol in the image has been decoded, the part of the information code seen in the image may be decoded. For the decoding, two memory buffers associated with the decoding module are used. Each of them has the same size as the piece of information coded in the information code, i.e. 128 bits in this example. In the following the memory buffers are called an accumulator buffer acc and a contributor buffer con.

For each coding symbol in the image belonging to the information code the following steps are carried out:
1) the distance offs between the center of the coding symbol and the associated grid intersection is calculated.
2) integer xi, integer yi and integer bit_number are calculated in the same way as indicated above.
3) Permuted-bit-number is calculated using P, xi, yi and bit-number.
4) The accumulator buffer acc is updated with offs: acc[permuted_bit_number]+=offs
5) The contributor buffer con is updated with 1: con[permuted_bit_number]+=1

Thus the accumulator buffer accumulates the respective displacements for the different code elements of the information code, whereas the contributor buffer keeps track of how many times a specific bit of the information code has been seen by the pen.

When all the images have been processed as indicated above, the resulting offsets are calculated for all information item elements: offset[n]=acc[n]/con[n], where n is an index between 1 and 128. If con has a value of 0 for any information item element that means that this information item element is missing from this stroke.

As an alternative, the contributor buffer may be updated not by 1, but by a value reflecting the reliability of the observation of the relevant coding symbol of the information code. Coding symbols close to the edges of an image may e.g. be given less weight because they are typically more affected by perspective distorsions.

Then a threshold is applied and bit values are assigned accordingly:

if offset [n]>threshold_value, then bit[n]=1 else bit[n]=0

If an error-correction mechanism was used when coding the combined code, the decoding process now also uses the same error-correction mechanism to detect and correct for errors and/or missing bits.

The above processing of the electronic representations results in a series of positions which constitutes an electronic representation of the pen movement over the base during one or more pen strokes, that is in one or more electronic pen strokes. It also results in a decoded information item.

In a final step, the decoding process may associate the information item with the electronic pen strokes. As indicated above, each position obtained from the position code may be converted to a page indication and a local position on that page. A pen stroke may typically be represented as a page indication and a series of local positions. In this way the pen is capable of keeping track of which page a stroke is written on. When an information item has been decoded, the decoding process may check if an information item already has been decoded and associated with the current page. If so, the decoding process may optionally check bit-for-bit consistency with the previously stored information item. If the bit data of the current information item is sufficiently similar to the bit data of the previous information item, then the bit data for the different pen strokes may be aggregated. In this way the likelihood of a correct decoding of the information item may be increased. If, on the contrary, the bit data of the decoded information items are radically different, this might indicate that two different pages have been written on, and the decoding process may take appropriate action.

Sometimes it may be desirable to use the combined code on a multi-page document. If the decoding process has the possibility to establish that pen strokes made on different pages of a multi-page document belong to one and the same document having the same information code on all the pages, it may use this fact to gather information about the information item from all the pen strokes on the different pages and thereby increase the possibility of correct decoding of the information item. The decoding process may for instance have access to information which indicates that specific groupings of pages may never represent separate documents, but only appear in multi-page documents. The decoding process may also or alternatively compare information bit data decoded from pen strokes from different pages as indicated above and make assumptions about connected pages based on the similarity of the data.

Correspondingly, the decoding process may either have access to information about the cell size used for the information code on specific pages. Alternatively the decoding process may perform the decoding in parallel for different cell sizes. When information bit data gathered from different pen strokes is compared, it will soon be evident which cell size is used for the coding.

In the above example a combined code is decoded. In another embodiment, a base is provided only with a position code, which may be decoded as described above.

FIG. 9 schematically shows an example of an installation in a user's personal computer which allows for local on-demand generation of coded bases. The installation comprises a code assigner 90, which is part of or associated with a printer driver 91, a position code repository 92 and an association database 93.

Now assume that the user X wants to print a document A.doc that he has created. In this example the document is a text document, but it can be any document that can be created in his computer, like a document in an image format, a calculation sheet, a presentation, etc.

The user opens the document A.doc in an application program 94. He then invokes a print command in the application. As a response, the code assigner 90 selects at least one of the subsets stored in the position code repository, in this case the subset identified as page 123. The selection may, but need not necessarily, be carried out in a randomized fashion.

The subsets may for instance be stored in the form of a page address or other page identity which unambiguously identifies a subset of the position code, two opposite corner positions for the subset of the position code, a file with an algorithm for generating the subset of the position code, a file containing the subset of the position code, or a single position in the subset from which the code assigner 90, having knowledge about the size of the subset, may calculate the other positions of the subset of the position code. If the code assigner 90 has to carry out calculations in order to provide the subsets of the position code, it includes suitable algorithms therefore.

The code assigner 90 may in one embodiment include a coding module for generating the code of the selected subset of the position code. If the subsets are stored in the position code repository in the form of already generated position code for the respective subsets, no coding module may be needed. If the position code repository stores the subset in the form of an identification of the subset without any generated position code, the identification of the selected subset may be sent to a coding module outside the code assigner for generation of the corresponding position code.

As already indicated the subsets may be divided into chunks. As an example, the overall position code described above may contain “segments” which in turn are divided into a number of “shelves”, each containing a number of “books” which are divided into a number of page units. Suitably, all page units have the same format within one level of the above position code hierarchy. For example, some segments or shelves may consist of page units in A4 format, while other consists of page units in A5 format. The identification of a certain page unit in position code can be noted as a page address of the form: segment.shelf.book.page, for instance 99.5000.1.1500, more or less like an IP address. For reasons of processing efficiency, the internal representation of the page address may be different, for example given as an integer of a predetermined length, e.g. 64 bits.

In one example, a segment may consist of more than 26,000,000 page units, each with a size of about 50×50 cm2. In one embodiment, at least one such segment is divided into 5,175 shelves, each consisting of 2 books with 2,517 pages each.

The above-mentioned chunks may e.g. correspond to books in the above hierarchy and the subsets may correspond to page units.

When the document, to which position code is to be assigned, is a multi-page document, the code assigner 90 may assign one specific subset to each page of the document. The subsets may then be selected from one and the same chunk.

Alternatively, there is no grouping of the subsets into chunks. In the case of a multi-page document, the code assigner simply selects a number of subsets, which may be close to each other or neighboring in the overall position code. In comparison with the grouping into chunks, this dynamic assignment is more efficient with regard to position code usage.

Having assigned the position code, the code assigner 91 may store an association between the document A.doc and the assigned page 123 in the association database 93 in the computer. If the document is a multi-page document, it may suffice to store the subset assigned to the first page, if the subdivision into chunks is known.

Next the code assigner 90 may create an information code which may be overlaid on the generated electronic position code by modifying the position code. In this example the information code codes an information item 95 in the form of the e-mail address: J_Doe@j.com. This information item may have been previously stored in the computer, e.g. in connection with the installation of the position assigner and the position code repository. Otherwise, the code assigner may prompt the user for the input of an information item.

Finally the print driver 91 may put together a print file including the document A.doc with the combined position and information code assigned thereto. The print file may be transferred to a local printer for printing or sent to another user's computing apparatus for subsequent printing. The printed document 96 comprises the text (not shown in FIG. 9) of the A.doc created by the user and the combined position and information code, which is schematically shown as a dot pattern in FIG. 9.

The code assigner 90, the position code repository 92, the association database 93 and the user data may be designed to be available to all applications installed on the user's computer.

FIG. 10 schematically shows how any pen stroke made on the printed base 96 may be incorporated in the A.doc. When a digital pen 5 is used on the document A.doc, it images the combined code locally at the tip of the pen. The parts of the combined code appearing in the images are decoded as described above. The decoding will result in an indication of the page on which the pen strokes were drawn (page 123), a representation of the pen strokes in the form of local position indications, and an information item (J.Doe@j.com) which in this case is the e-mail address of X.

As indicated above the pen 5 may include a definition of the chunks of the position code repository. Using this definition, the pen may identify pages belonging to a multi-page document and use pen strokes made on different pages to gather the information needed in order to be able to decode the information code.

Even if the subsets of the position code has been dynamically assigned to a document, i.e. without utilizing chunks, the digital pen 5 may identify pen strokes relating to a multi-page document. When a pen stroke has been decoded, the information item elements decoded from that pen stroke may be compared with the information item elements of the previous pen stroke. If the data is sufficiently similar the pen may conclude that it relates to one and the same document and merge the data.

The pen 5 may now send the recorded pen strokes to a predefined network-connection device, such as a PC, a mobile phone, a PDA or the like, which creates an e-mail, a fax message, an SMS or any other message containing the indication of the page (page 123) and the local position indications (here representing coordinate pairs forming an handwritten alpha-sign), and sends it to X's computer 10.

In another embodiment, at least part of the decoding of the combined code is carried out in another unit to which the pen sends information.

X's computer may have a pen stroke handler 97, which scans through received messages and picks out pen stroke information. For each received pen stroke the page address indication is compared with the entries in the association database 93. In this example, the pen stroke handler 97 will find that the received pen strokes are to be inserted in document A.Doc, which may subsequently be printed out or displayed to X.

The pen stroke messages can also contain data relating to user Y, enabling the user X to e.g. see who the originator of the strokes was. Application software can utilize this to do advanced per-user processing like filtering, aggregation of statistics, etc

In the example above, the position code to be printed on the document was assigned in a user's personal computer. In another embodiment the position code may be centrally assigned by a network-based position assigner. An information item may then be coded into the position code in the user's personal computer and the document may be printed locally with the position code and/or the information code. If the association database 93 stores an association between the assigned position data and the document A.Doc, the pen stroke handler 97 may handle the pen strokes as described above.

1. A personal computing apparatus comprising
a position code repository, which stores a representation of a plurality of subsets of a position code, and
a code assigner, which on request assigns at least one of said subsets to a document stored in the personal computing apparatus.

2. A personal computing apparatus as claimed in claim 1, wherein said code assigner uses a randomized algorithm to select said at least one subset.

3. A personal computing apparatus as claimed in claim 1 or 2, wherein the code assigner is configured to cycle through all said plurality of subsets before selecting a subset for a second time.

4. A personal computing apparatus claim 1, wherein said plurality of subsets of the position code is divided into chunks of related subsets, said code assigner being configured to select subsets from one chunk when assigning subsets to a multi-page document.

5. A personal computing apparatus as claimed in claim 1, further comprising an association database, in which the code assigner stores an association between the document and the assigned subset of the position code.

6. A personal computing apparatus as claimed in claim 1, wherein the code assigner further assigns an information code, which codes non-positional information, to the document.

7. A personal computing apparatus as claimed in claim 6, wherein said information code repeatedly codes a non-positional information item and is overlaid on the position code.

8. A personal computing apparatus as claimed in claim 1, further comprising a printer for printing said document provided with the subset of the position code assigned to the document on a base.

9. A personal computing apparatus as claimed in claim 1, further comprising a pen stroke associator, which is configured to receive pen strokes, which are electronically recorded from a print-out of said document provided with said position code, and to associate said pen strokes with said document stored in the personal computing apparatus.

10. A personal computing apparatus as claimed in claim 1, wherein at least a plurality of said subsets of the position code are non-unique within an information management system which comprises a plurality of personal computing apparatuses each comprising a position code repository, which stores a representation of a plurality of subsets of the position code

11. A personal computing apparatus as claimed in claim 1, wherein said representation of a plurality of subsets of the position code comprises, for each one of said subsets, at least one of a subset identity indication, which unambiguously identifies the position code area of the subset, two opposite corner positions for the position code area of the subset, an algorithm for generating the position code of the subset, or the position code of the subset.

12. A network-based information management system, comprising a plurality of personal computing apparatuses according to claim 1.

13. A method in a personal computing apparatus, comprising
providing a document, and
assigning at least one subset from a representation of a plurality of subsets of a position code stored in the apparatus to the document.

14. A method as claimed in claim 13, further comprising using a randomized algorithm to select said at least one subset.

15. A method as claimed in claim 13 or 14, further comprising cycling through all said plurality of subsets before selecting a subset for a second time.

16. A method as claimed in claim 13, wherein said plurality of subsets of the position code is divided into chunks of related subsets and further comprising selecting subsets from one chunk when assigning subsets to a multi-page document.

17. A method as claimed in claim 13, further comprising storing, in the personal computing apparatus, an association between the document and the assigned subset of the position code.

18. A method as claimed in claim 13, further comprising assigning an information code, which codes non-positional information, to the document.

19. A method as claimed in claim 18, further comprising repeatedly coding a non-positional information item in said information code and overlaying the information code on the position code.

20. A method as claimed in claim 13, further comprising printing said document provided with the subset of the position code assigned to the document on a base.

21. A method as claimed in claim 13, further comprising receiving, in said personal computing apparatus, pen strokes, which are electronically recorded from a print-out of said document provided with said combined code, and associating said pen strokes with said document stored in the personal computing apparatus.

22. A method as claimed in claim 13, wherein at least a plurality of said subsets of the position code are non-unique within an information management system which comprises a plurality of personal computing apparatuses each comprising a position code repository, which stores a representation of a plurality of subsets of the position code

23. A method as claimed in claim 13, wherein said representation of a plurality of subsets of the position code comprises, for each one of said subsets, at least one of a subset identity indication, which unambiguously identifies the position code area of the subset, two opposite corner positions for the position code area of the subset, a file with an algorithm for generating the position code of the subset, or a file containing the position code of the subset.

24. A computer-readable storage medium, comprising a set of instructions, which, when executed on a computer, performs the method as claimed in claim 13.
